(19) United States
(12) Patent Application Publication
(10) Pub. No.: US 2021/0318869 A1
(43) Pub. Date: Oct. 14, 2021

(54) NTT PROCESSOR INCLUDING A PLURALITY OF MEMORY BANKS

(71) Applicant: COMMISSARIAT A L'ENERGIE ATOMIQUE ET AUX ENERGIES ALTERNATIVES, Paris (FR)

(72) Inventors: Joel CATHEBRAS, Palaiseau (FR); Alexandre CARBON, Massy (FR); Renaud SIRDEY, Cernay-La-Ville (FR); Nicolas VENTROUX, Gif-Sur-Yvette (FR)

(73) Assignee: COMMISSARIAT A L'ENERGIE ATOMIQUE ET AUX ENERGIES ALTERNATIVES, Paris (FR)

(21) Appl. No.: 17/259,092

(22) PCT Filed: Jul. 9, 2019
(86) PCT No.: PCT/FR2019/051697

§ 371 Date: Jan. 8, 2021

(30) Foreign Application Priority Data
Jul. 10, 2018 (FR) 1856351

(51) Int. Cl. G06F 9/30; G06F 12/0875

(52) U.S. Cl. CPC G06F 9/3001; G06F 2212/1008; G06F 12/0875

(57) ABSTRACT

The present invention relates to a stream-based NTT processor comprising: a plurality (K) of processing stages (210ₖ, k=0, . . . , K−1) organised in a pipeline (210); a plurality (G+1) of memory banks (220_{g}, g=0, . . . , G); a read management module (260) for reading, within one memory) of a memory bank (220_{g}) of the processor, sets of twiddle factors intended for parameterising a processing stage (210ₖ); a write management module (270) for receiving, in the form of successive blocks, a set of twiddle factors and writing said sets of twiddle factors into the memories of a memory bank, the writing being carried out cyclically in the memory banks, each new set of twiddle factors being written into a new memory bank; and a control module for controlling the writing and reading of twiddle factors as well as the progression of data blocks through the processing stages.

### TECHNICAL FIELD

This invention relates to the field of NTT (Number Theoretic Transform) processors. Its applications are particularly in Euclidean network cryptography, and particularly in homomorphic cryptography.

### STATE OF PRIOR ART

Number Theoretic Transform (or NTT) has been known since the 1970s and has recently been found to be advantageous in cryptographic applications.

It will be recalled that a number theoretic transform is the equivalent of a Fourier transform in a Galois field with characteristic q, GF(q), the primitive root of unity of a Nth order Fourier transform in □, namely

$${e}^{j \frac{2 π}{N}} ,$$

being replaced by an Nth root of unity of the field GF(q). Thus, N is the smallest non-null integer n such that ψⁿ=1. The number theoretic transform of a sequence a=a₀, . . . , a_{N-1} of N elements of GF(q) is defined by a sequence A=A₀, . . . , A_{N-1} such that:

$${A}_{k} = {\sum }_{n = 0}^{N - 1} {a}_{n} {ψ}^{nk} \qquad ( 1 )$$

in which the addition and multiplication operations are those of the field GF(q).

It should be noted that ψ is not necessarily a primitive root of GF(q), in other words its order is not necessarily equal to the order q−1 of the multiplication group of GF(q) but that the order N of ψ is necessarily a divider of q−1.

If N and q are coprime, there is an inverse N⁻¹ in the Galois field GF(q) and the inverse number theoretic transform (Inverse NTT) can be defined by:

$${a}_{n} = {N}^{- 1} {\sum }_{k = 0}^{N - 1} {A}_{k} {ψ}^{- nk} \qquad ( 2 )$$

the inverses ψ^{-nk} existing provided that GF(q) is a field.

By analogy with the Fourier transform, the elements ψ^{nk} and ψ^{-nk} appearing in the expression (1) or (2) are called twiddle factors.

In general, the characteristic q of a field is in the form q=p^{m} wherein p is a prime number and m is a non-null integer. In the following we will consider finite fields GF(q) for which the characteristic is a prime number p, that are known to be isomorphic to □ₚ=□/p□.

A general presentation of NTT can be found in the paper by J. M. Pollard “The fast Fourier transform in a finite field” published in Mathematics of Computation, vol. 25, No. 114, April 1971, pp. 365-374.

The NTT transform is used in RNS (Residue Number System) arithmetic in the context of Euclidean network cryptography in which it can considerably simplify the multiplication of high order polynomials with large coefficients.

It is known that the multiplication of two polynomials involves a calculation of the convolution of the sequence of coefficients of the first polynomial with the sequence of coefficients of the second polynomial. In using the dual space, in other words after NTT, the multiplication of polynomials then only requires a simple one by one multiplication of the transformed sequences. All that is then necessary is to perform an INTT on the resulting sequence to obtain coefficients of the sequence corresponding to the product of two polynomials.

This acceleration of the polynomial calculation can be applied to an RNS representation of the polynomials. More precisely, if a polynomial

$$f ( x ) = {\sum }_{i = 0}^{N - 1} {α}_{i} {x}^{i}$$

is considered, it can be made to correspond to a set L of polynomials

$${f}^{( ℓ )} ( x ) = {\sum }_{i = 0}^{N - 1} {α}_{i}^{( ℓ )} {x}^{i}$$

wherein [symbol] =αᵢ mod [symbol] and [symbol] , [symbol] =0, . . . , L−1 are coprime (and generally prime) integers, chosen to be relatively small. The set {p₀, . . . , p_{L-1}} is called the RNS base.

This representation of coefficients and consequently the associated polynomial is an immediate application of the Chinese Remainders Theorem (CRT). The CRT (αᵢ)={αᵢ⁽⁰⁾, . . . , αᵢ^{(L-1)}} and CRT(∫)={∫⁽⁰⁾, . . . , ∫^{(L-1)}} notation will be used in the following.

Conversely, an RNS representation

$${f}^{( ℓ )} ( x ) = {\sum }_{i = 0}^{N - 1} {α}_{i}^{( ℓ )} {x}^{i} ,$$

[symbol]

=0, . . . , L−1 can be associated with a polynomial f=ICRT{f⁽⁰⁾, . . . , f^{(L-1)}} defined by

$$f ( x ) = {\sum }_{i = 0}^{N - 1} {α}_{i} {x}^{i} ,$$

wherein the coefficients αᵢ=ICRT{αᵢ⁽⁰⁾, . . . , αᵢ^{(L-1)}} are given by:

$${α}_{i} = {\sum }_{ℓ = 0}^{L - 1} ( \frac{P}{{P}_{ℓ}} ) ( {( \frac{P}{{p}_{ℓ}} )}^{- 1} \cdot {α}_{i}^{( ℓ )} mod {p}_{ℓ} ) mod P \qquad ( 3 )$$

and wherein

$$P = {\prod }_{ℓ = 0}^{L - 1} {p}_{ℓ}$$

is the product of the prime numbers used for the RNS decomposition of the coefficients.

Thus, the multiplication of two polynomials with degree N,

$$f ( x ) = {\sum }_{i = 0}^{N - 1} {α}_{i} {x}^{i} and g ( x ) = {\sum }_{i = 0}^{N - 1} {β}_{i} {x}^{i}$$

can be converted by RNS representation and NTT transform to N.L multiplications of coefficients

$${A}_{k}^{( ℓ )} = {\sum }_{i = 0}^{N - 1} {{α}_{i}^{( ℓ )} ( {ψ}_{ℓ} )}^{ik} and$$

$${B}_{k}^{( ℓ )} = {\sum }_{i = 0}^{N - 1} {{β}_{i}^{( ℓ )} ( {ψ}_{ℓ} )}^{ik} ,$$

k=0, . . . , N−1 in dual space wherein ψₗ is an Nth root of unity of the field [symbol] and [symbol] , [symbol] are elements of [symbol] obtained by decomposition of the coefficients αᵢ and βᵢ in the RNS base {p₀, . . . , p_{L-1}}. It is then possible to return to the initial space using an inverse transform INTT of each sequence of coefficients [symbol] = [symbol] , k=0, . . . , N−1 to obtain the coefficients in an RNS representation

$${γ}_{k}^{( ℓ )} = {N}^{- 1} {\sum }_{i = 0}^{N - 1} {{C}_{k}^{( ℓ )} ( {ψ}_{ℓ} )}^{ik}$$

and then the coefficients of the product polynomial h(x)=f(x)g(x) by ICRT. Given that the degree of h(x) is 2N, polynomials of degree N′=2N (and therefore the N′th roots of unity) can immediately be considered by zero padding with N zeroes of the N coefficients of the highest degrees of f(x) and g(x). Based on this convention, the same space can be used for the product polynomial and the polynomials f(x) and g(x) to be multiplied.

A detailed description of the application of the NTT transform to the multiplication of polynomials in a CRT representation can be found in the paper by W. Dai et al. entitled “Accelerating NTRU based homomorphic encryption using GPUs” published in Proc. of IEEE High Performance Extreme Computing Conference (HPEC), 2014, 9-11 Sep. 2014.

A polynomial multiplication using an NTT transform of polynomial coefficients represented in an RNS base requires the use of roots of unity ψₗ of finite fields [symbol] and of their powers ( [symbol] )ⁿ, n=0, . . . , N−1, both to calculate the NTT transform of the coefficients (in RNS representation) of the polynomials to be multiplied and to calculate the INTT transform of the coefficients (in RNS representation) of the product polynomial in dual space.

As for the FFT (Cooley-Tukey algorithm), it has been proposed to implement the NTT transform by means of a pipeline architecture (stream processing), each stage carrying out one operation (radix) on a base block with size R (traditionally R=2 or R=4). The paper by D. B. Cousins et al. entitled “Designing an FGPA-accelerated homomorphic encryption co-processor” published in IEEE Trans. on Emerging Topics in Computing., vol. 5, No. 2, April-June 2017, pp. 193-206 presents an NTT stream processor architecture making use of a conventional FTT radix-2 architecture.

However, this NTT stream processor requires storage of a large number of sets of twiddle factors in memory, corresponding to the different finite fields involved in an RNS representation. Large ROM memories are necessary since these finite fields can differ from one RNS representation to another. By default, it would be possible to store only L sets of twiddle factors corresponding to a specific RNS representation but then the NTT processor would not provide any flexibility: reprogramming of memories would be necessary when it is required to change the RNS representation base.

The invention aims to disclose an NTT stream processor that provides good flexibility on the possible bases for the RNS representation with requiring large local memory resources.

### PRESENTATION OF THE INVENTION

This invention is defined by an NTT stream processor comprising a plurality K of processing stages organised in pipeline, each stage comprising a permutation module followed by a radix module, each data sequence to be transformed being input to the processor in the form of N̅=N/W successive data blocks with size W, the result of the NTT transform of this data sequence also being supplied in the form of a sequence of N̅ blocks with size W, said NTT stream processor comprising:
a plurality (G+1) of memory banks, each memory bank being associated with an NTT transform with size N on a given field ( [symbol] ) and comprising K memories (MEMₖ^{g}, k=0, . . . , K−1) associated with K corresponding processing stages, each memory being designed to store a set of twiddle factors to configure a processing stage;
a write management module to receive a set ( [symbol] ) of twiddle factors composed of K sets of twiddle factors ( [symbol] , k=0, . . . , K−1), in the form of a sequence of successive blocks with size W, and to write these twiddle factors into corresponding memories of a memory bank, the write being done cyclically in the memory banks, each new set of twiddle factors being written in a new memory bank;
a read management module to read sets of twiddle factors within memories (MEMₖ^{g}) of a memory bank of the processor and to configure the processing stages at the rate of progress of the data blocks through the processing stages;
a control module to control the write management module, the read management module and the progress of data blocks through the processing stages.

Said NTT stream processor may comprise G+1 memory banks wherein G=┌Lat_NTT/T┐, Lat_NTT being the processing latency of the NTT processor and T=N/W is the data sequence flow rate at the input to the NTT processor, each memory bank being associated with the transform of a data sequence and containing the sets of twiddle factors of successive stages for the NTT transform of this sequence.

Advantageously, before a data sequence passes from a first processing stage to a second processing stage, the control module controls reading of the set of twiddle factors in the corresponding memory associated with this second stage within the memory bank associated with this sequence, and programming of the second stage using the set of twiddle factors thus read.

The control module preferably comprises a memory banks counter, incremented each time that a new set of twiddle factors is supplied to the write management module and reset to zero after reaching the value G, the output from said counter being compared with a plurality of comparators to be compared with the values g=0, . . . , G, the corresponding outputs from these comparators providing G+1 selection signals enabling one write command in each corresponding memory bank.

Each memory bank associated with the NTT transformation of a sequence can also comprise a register in which is stored the characteristic ( [symbol] ) of the field ( [symbol] ) in which the NTT transform is made, the characteristic of the field being transmitted to a processing stage at the same time as the twiddle factors read in the memory associated with this stage, in said memory bank.

Typically, the characteristics of the fields in which are made L NTT transforms of L successive data sequences are distinct, wherein L≤G.

### BRIEF DESCRIPTION OF THE DRAWINGS

Other characteristics and advantages of the invention will become clear after reading a preferred embodiment of the invention, described with reference to the appended figures among which:

FIG. 1 diagrammatically represents the architecture of an NTT stream processor;

FIG. 2 diagrammatically represents the architecture of an NTT stream processor according to one embodiment of the invention;

FIG. 3 diagrammatically represents a write operation in a memory bank in FIG. 2;

FIG. 4 diagrammatically represents operation of the write interface in the NTT processor in FIG. 2;

FIG. 5 diagrammatically represents a read operation in the memory banks in FIG. 2;

FIG. 6 diagrammatically represents a chronogram of control signals in the NTT processor in FIG. 2.

### DETAILED PRESENTATION OF PARTICULAR EMBODIMENTS

An NTT stream processor comprises essentially a plurality of calculation stages, each stage comprising a permutation module adapted to perform a permutation operation and a combination module adapted to perform a combination operation (butterfly radix-R) on R integer numbers making use of twiddle factors belonging to a field □ₚ=□/p□ with characteristic p.

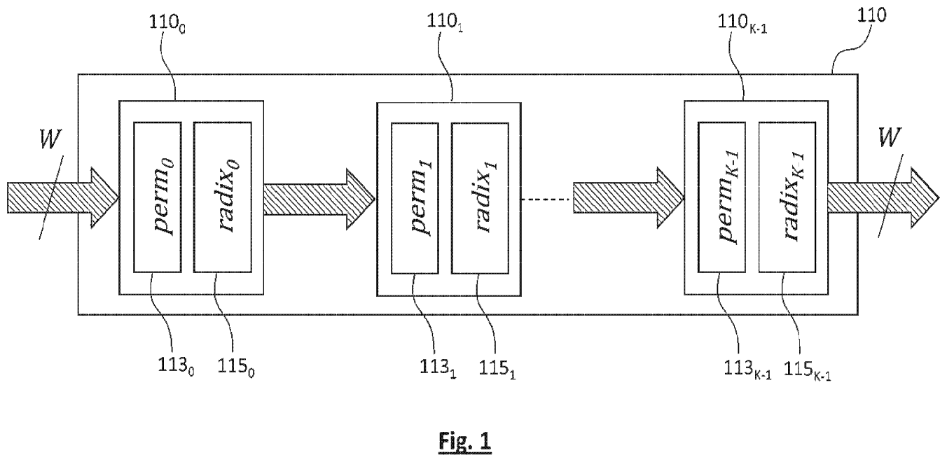

FIG. 1 diagrammatically illustrates the architecture of an NTT stream processor.

The input data are relative integers (elements of □) and are supplied in blocks with size W to the NTT processor, 100. In other words, W is the width of the data path. Thus, if N (or the number of points) is the size of the NTT transform, and if a block is supplied to the processor during each clock cycle, the entirety of a sequence of N elements, hereinafter referred to as an N-sequence, will be received after time T=N/W (counted as a number of cycles), in other words the input flow rate (of data sequences) is equal to N/W.

The NTT processor comprises a plurality K of processing stages, 110₀, . . . , 110_{K-1}, arranged in pipeline, 110, each stage 110ₖ comprising a permutation module 113ₖ, followed by a combination module, 115ₖ, forming a combination operation on R integers supplied by the permutation module 113ₖ making use of N/R^{K-k-1} twiddle factors (in the case of an implementation by time decimation) or R^{K-k-1} (in the case of an implementation by frequency decimation). Thus, each stage is configured by an associated set of twiddle factors.

In the remainder of the presentation, in the interests of simplification and without any loss of generality, we will assume that R=W. Furthermore, the size (or the number of points) N of the NTT transform is related to the number of stages in the processor by K=log_{R}(N).

Each permutation module comprises switches and delays (FIFO buffers) so as to present the R integers to be combined to the next combination module simultaneously. The architecture of these permutation modules has been described for example in patent US-B-8321823 incorporated herein by reference.

The combination modules perform the radix-R operations (as for an FFT) making use of twiddle factors supplied to them, the calculations being made in the field [symbol] ₚ.

The flow rate through each stage of the NTT processor, in other words the time after which an N-sequence of data is processed by this stage, is equal to T so that a stream operation can be performed.

Since the data N-sequences are supplied to the NTT processor with flow rate T=N/W, the maximum number of N-sequences present in the processor at any moment is G=┌Lat_NTT/T┐ wherein Lat_NTT is the processing latency of the NTT processor expressed as a number of clock cycles.

The architecture of the NTT stream processor according to this invention enables the NTT transform to be made on L≤G distinct fields in pipeline, which is particularly advantageous when operations have to be carried out in RNS representation.

The basic concept of this invention is to enable each stage k=0, . . . , K of the NTT processor to access the set of twiddle factors [symbol] associated with this stage and the N-sequence of data currently being processed by this stage, said twiddle factors belonging to [symbol] ={( [symbol] )ⁿ, n=0, . . . , N−1} wherein [symbol] =1, . . . , L, the NTT transforms on the different fields [symbol] taking place simultaneously on data blocks within the successive stages of the processor, access of the different stages to the sets [symbol] being made synchronously with the progress of the N-sequences of data from one stage to the next.

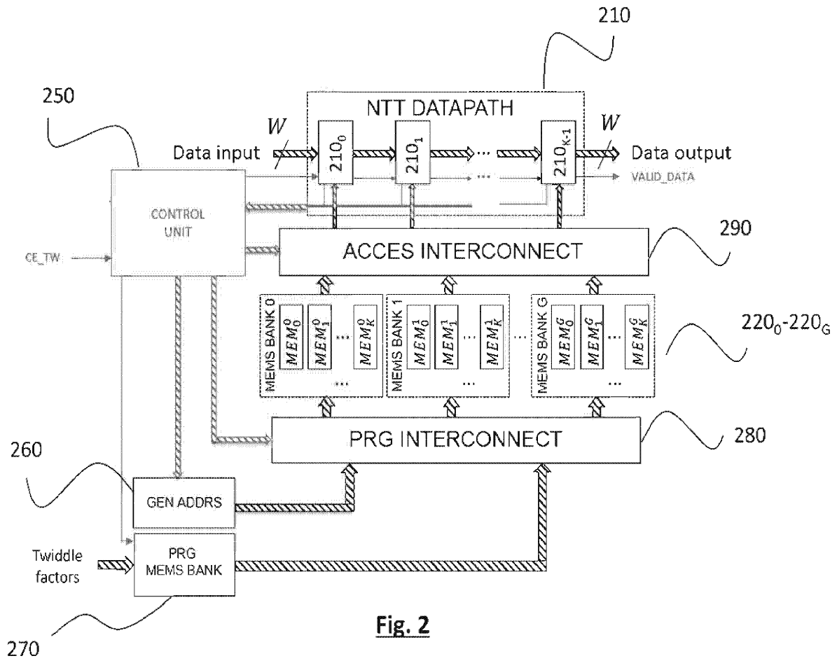

FIG. 2 diagrammatically represents an architecture of an NTT stream processor according to one embodiment of the invention.

The NTT processor comprises a control module 250, a plurality K of processing stages, 210₀, . . . , 210_{K-1}, arranged in pipeline, 210, these processing stages having the structure previously described in relation to FIG. 1. The N-sequences of data on which the NTTs are performed are input through the first stage 210₀ in the form of a series of blocks with size W at a flow rate T=N/W (i.e. one N-sequence per time interval T) and the result of each NTT is supplied by the last stage, 210_{K}, in the form of a series of blocks with size W, at the same flow rate. It is important to note that the size is common to all NTTs performed by the processor, regardless of the fields in which they are calculated.

The different stages are programmed using G+1 memory banks 220₀, . . . , 220_{G}. Each memory bank, 220_{g}, comprises K memories, MEMₖ^{g}, with index k=0, . . . , K−1, each memory MEMₖ^{g} containing the set of twiddle factors [symbol] necessary for setting parameters (in other words for programming) the corresponding stage 210ₖ when this stage is to be performed in the field [symbol] . Furthermore, the memory bank 220_{g} stores the characteristic [symbol] of the field in which the combination operations will be done in a register (not shown). This characteristic is also supplied to the stage 210ₖ so that the combination module of this stage can perform the operations (multiplication by a twiddle factor, addition, subtraction) modulo [symbol] .

A stage with given index k accesses a single memory bank at each instant. It should be noted that the contents of different memory banks can be different or identical, depending on whether successive NTT transforms are made on different or identical fields. It is important to understand that each memory bank is associated with a sequence of N̅=N/W data blocks (with size W) that passes through the successive stages of the NTT processor to supply an NTT transform in a field [symbol] . When these N̅ blocks pass in a stage 210ₖ, this stage will previously have accessed the memory with index k of the bank 220_{g} containing the set of twiddle factors [symbol] , to be configured by this set. A transform can then be made on the N̅ following blocks in the same field [symbol] or in a different field [symbol] . In the first case, the memory bank 220_{g+1} (if it is assumed that g<G) will contain the same sets of twiddle factor [symbol] , k=0, . . . , K−1 as the memory bank 220_{g}. In the second case, it will contain the sets of twiddle factors [symbol] , k=0, . . . , K−1.

Each stage 210ₖ cyclically accesses memories with index k, MEMₖ^{g} of memory banks 220_{g}, g=0, . . . , G. It should be noted that when a stage 210ₖ has been configured by means of the memory MEMₖ^{G} of the memory bank 220_{G}, it is then configured using the memory MEMₖ⁰ of the memory bank 220₀ for the next sequence of N̅ blocks. In this implementation, the number of memory banks (G+1) is one higher than the maximum number (G) of different sequences simultaneously present in the NTT processor to enable writing of the twiddle factors in a memory bank before a new sequence of N̅ blocks is engaged in the pipeline of the NTT processor.

The function of the control block 250 is particularly to control writing of twiddle factors in the memory banks 220_{g}, g=0, . . . , G and to read these twiddle factors within the memory banks to configure stages 210ₖ, k=0, . . . , K−1.

More precisely, the control module 250 controls the read management module 260, the write management module, 270, the memory bank write interface, 280, and the memory bank read interface, 290. The control module 250 selects memory banks individually so that each can be accessed in write or in read.

The read management module, 260 is responsible for the generation of read addresses. It comprises K output ports, each output port with index k providing the address addrₖ to be read in the selected memory bank to configure the corresponding stage 210ₖ.

The function of the write management module, 270, is primarily to generate a write command prg_weₖ, k=0, . . . , K−1 and a write address prg_addrₖ, k=0, . . . , K−1, for each memory in the memory bank. Only the memory for which the write command is activated is accessed in write at address prg_addrₖ. It is understood that when a selected memory bank is not accessed in writing, it can be accessed in reading.

Another function is to provide twiddle factors, denoted as prg_dat [symbol] , k=0, . . . , K−1, that will be written in the corresponding memories of the selected memory bank, and the characteristic [symbol] of the field to be written in the register of the selected memory bank.

These twiddle factors may have been previously stored in an external memory and provided to the memory banks, through a FIFO buffer provided in the write management module, 270. Alternatively, the twiddle factors can be supplied directly by a twiddle factor generation circuit like that described in application FR1856340 deposited on the same day and incorporated herein by reference. It will be remembered that such a circuit can provide twiddle factors by blocks with size W with flow rate N/W.

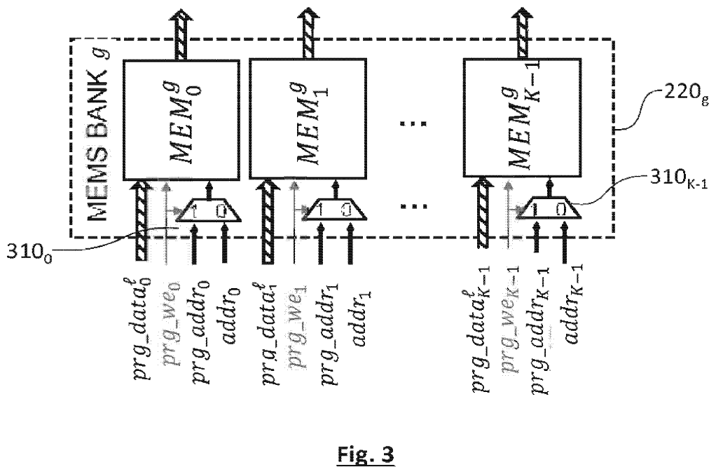

FIG. 3 diagrammatically represents a write operation in a memory bank in FIG. 2.

This figure shows the memory bank 220_{g}, herein assumed to be selected by the control module for the write operation. This memory bank contains the memories MEMₖ^{g}, k=0, . . . , K−1. Each memory MEMₖ^{g} receives successive twiddle factors on its data bus. When the twiddle factor prg_dat [symbol] is present on the data bus, the write control signal prg_weₖ writes it at the address addrₖ in the memory MEMₖ^{g}. More precisely, le signal prg_weₖ uses the multiplexer 310ₖ to select the write address between prg_addrₖ (address provided by the write management module) and the address (addrₖ provided by the read management module). Generation of addresses prg_addrₖ depends on the distribution of rotation factors [symbol] within the different successive blocks provided to the write management module. When these N̅ blocks are completed, the sets of twiddle factors [symbol] , k=0, . . . , K−1, are progressively present in the memories MEMₖ^{g}, k=0, . . . , K−1.

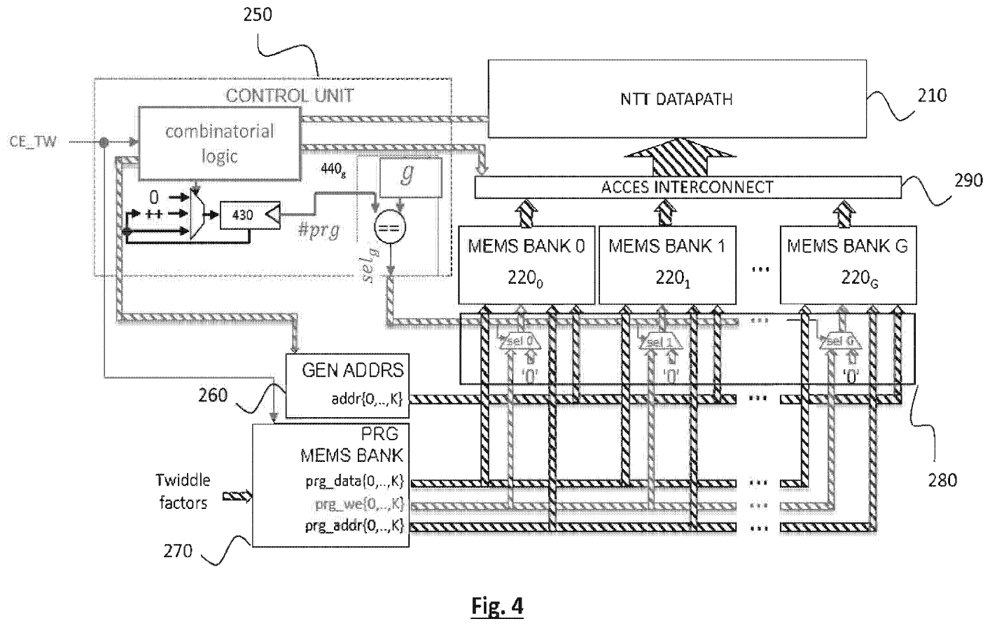

FIG. 4 diagrammatically illustrates operation of the write interface in the NTT processor in FIG. 2.

This figure once again shows the processing stages pipeline 210, the memory banks 220_{g}, g=0, . . . , G, the control module 250, the read management module 260, the write management module 270, the memory bank write interface, 280, and the memory bank read interface, 290.

The control module 250 comprises a memory bank write counter, 430, that is incremented each time that the signal CE_TW becomes active, in other words each time a new set of twiddle factors is supplied to the write management module 270. When the counter 430 reaches the value G, the next increment resets its output to zero. In other words, the memory banks are cyclically addressed in writing.

The output from the counter 430 is compared with the values 0, . . . , G using G+1 comparators 440_{g}, g=0, . . . , G. The outputs from each of these comparators provide signals sel_{g}, g=0, . . . , G. If the signal sel_{g} uses a first logical value (in this case “1”), the memory bank 220_{g} is selected in write, and if it takes on a second logical value (“0”), opposite to the first, this memory bank is not selected. The signal sel_{g} authorises the transmission of write control signals prg_weₖ, k=0, . . . , K−1 to the selected memory bank if it is equal to a first logical value, and inhibits this transmission (for example by means of an AND gate or a multiplexer) if it is equal to a second logical value, opposite to the first. In other words, if the memory bank 220_{g} is selected by the control module, the write control signals prg_weₖ, k=0, . . . , K−1 are transmitted to the different memories in the memory bank concerned, in the form of signals mem_{g_}prg_weₖ, k=0, . . . , K−1.

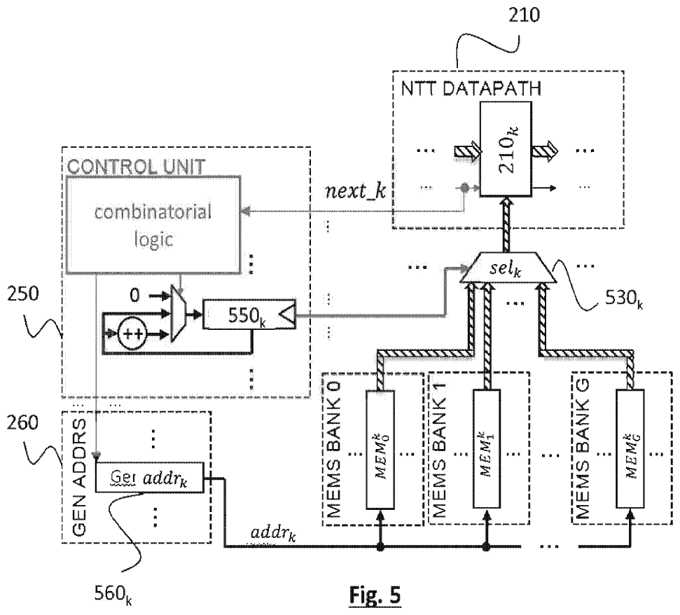

FIG. 5 diagrammatically represents a read operation in the memory banks in FIG. 2.

It is assumed herein that the control module would configure stage 210ₖ of the NTT processor.

The arrival of a new sequence of N̅ data blocks on the stage 210ₖ is identified herein by means of a control signal next_k. This signal increments a memory banks read counter, 550ₖ, specific to the stage 210ₖ. This signal controls a data multiplexer, 530ₖ, at the entry to stage 210ₖ. Furthermore, the signal next_k initialises an elementary addresses generator, 560ₖ, within the read management module, 260. This generator is initialised by the control signal next_k and provides the address addrₖ to be read in the memories, MEMₖ^{g}, g=0, . . . , G, at each clock cycle. The data read at each address in the memories concerned are selected by the multiplexer 530ₖ: only the twiddle factors read in the memory MEMₖ^{g} in which g is the number of the memory bank supplied by the counter 550ₖ, are transmitted to stage 210ₖ.

Thus, when the first data block sequence reaches stage 210ₖ, the rotation factors read from the memory MEMₖ⁰ are supplied to this stage to configure it, when the second data block sequence reaches the same stage, the twiddle factors read from the memory MEMₖ¹ are presented to it to configure it, and so on. When the memory MEMₖ^{G} of the last memory bank, 220_{G} is reached, the memory bank counter, 550ₖ, is reset to zero and the twiddle factors are once again read from memory MEMₖ⁰. The dynamic configuration process continues cyclically, for each stage of the NTT processor.

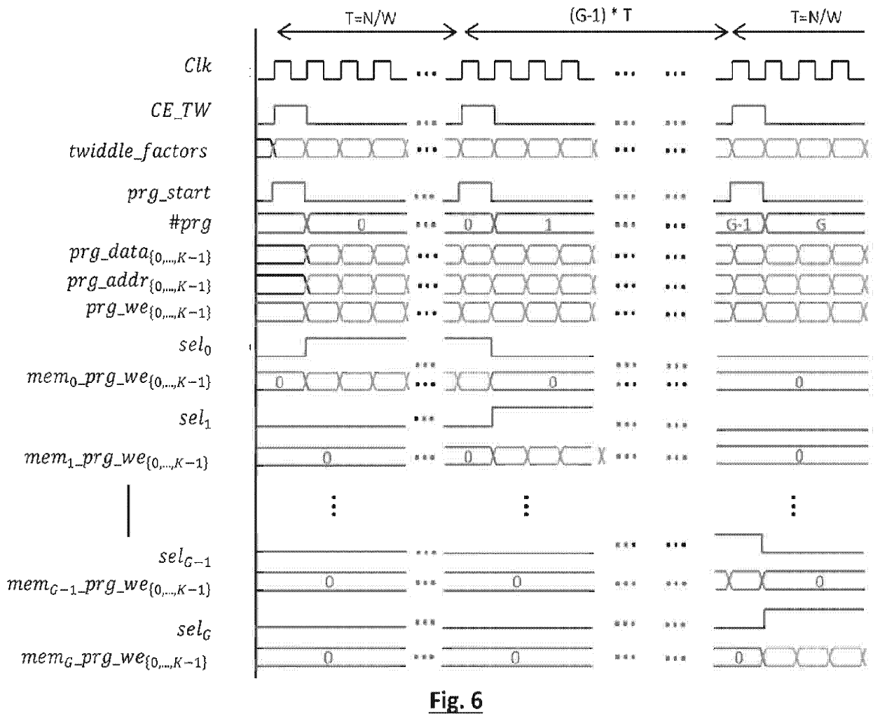

FIG. 6 diagrammatically represents a chronogram of control signals in the NTT processor in FIG. 2 during writing of twiddle factors in the memory banks.

Clk denotes the timer clock (size W) of the twiddle factor blocks. This same clock is also used to clock the arrival of data blocks (also with size W).

The signal CE_TW informs the processor that a new set of twiddle factors [symbol] ={( [symbol] )ⁿ, n=0, . . . , N−1} is available. This set of twiddle factors is supplied in the form of successive blocks with size W. This set of twiddle factors is broken down into sets of twiddle factors [symbol] , k=0, . . . , K−1 that will be stored in the K corresponding memories of a memory bank and will be used to configure the corresponding processing stages 210ₖ, k=0, . . . , K−1, when the data flow to be transformed passes through these stages. It is important to note that the twiddle factors of a set of twiddle factors can be distributed on several successive blocks of [symbol] .

The twiddle_factors line represents the twiddle factors. For each clock tick Clk, a block of W twiddle factors is supplied to the write management module 270.

The signal prg_start indicates the beginning of the write of a set [symbol] of twiddle factors in a memory bank.

The signal #prg represents the output from the memory bank write counter and the signals sel_{g}, g=0, . . . , G−1 are output signals from the comparators 440_{g}, g=0, . . . , G−1. When a signal sel_{g} is active (in this case logical level “1”), the memory bank 220_{g} is selected in writing.

The K signals prg_data_{{0, . . . , K-1}} represent data to be written in the corresponding memories MEMₖ^{g}, k=0, . . . , K−1 of the memory bank 220_{g} selected in write. More precisely, these data appear on the data bus that supplies all memory banks but will only be written in the selected memory bank.

Similarly, the K signals prg_addr_{{0, . . . , K-1}} represent the corresponding addresses in the memories MEMₖ^{g}, k=0, . . . , K−1 in which the data prg_data_{{0, . . . , K-1}} will be written. More precisely, these addresses appear on the address bus that supplies all memory banks but will only be used for the selected memory bank. The signals mem_{g_}prg_we_{{0, . . . , K-1}} are commands to write in the selected memory MEMₖ^{g}, k=0, . . . , K−1 In this case, the write command mem_{g_}prg_weₖ is simply the logical product sel_{g}.prg_weₖ: it triggers writing data prg_dataₖ at address prg_addrₖ in the memory MEMₖ^{g} of the selected memory bank, 220_{g}. As mentioned above, when a block of twiddle factors arrives, several memories MEMₖ^{g}, k=0, . . . , K−1 of the selected memory bank can be selected successively and addressed in writing.

It will be understood from this chronogram that memory banks are cyclically addressed in write so that successive sets of twiddle factors [symbol] can be stored in them, each set being composed of sets of twiddle factors [symbol] , k=0, . . . , K−1 that are stored in the corresponding memories of a memory bank and will be used to program the different corresponding processing steps of the NTT stream processor.

1. A NTT stream processor, comprising:
a plurality K of processing stages 210ₖ k=0, . . . , K−1 organized in pipeline, each stage comprising a permutation module followed by a radix module, each data sequence to be transformed being input to the processor in the form of N̅=N/W successive data blocks with size W, the result of the NTT transform of this data sequence also being supplied in the form of a sequence of N̅ blocks with size W;
a plurality (G+1) of memory banks 220_{g} g=0, . . . , G, each memory bank 220_{g} being associated with an NTT transform with size N on a given field ( [symbol] ₚ_{ₗ},) and comprising K memories (MEMₖ^{g}, k=0, . . . , K−1) associated with K corresponding processing stages 210ₖ k=0, . . . , K−1 each memory being designed to store a set of twiddle factors to configure a processing stage;
a write management module to receive a set (Ψₗ) of twiddle factors composed of K sets of twiddle factors (Ψₖ^{l}, k=0, . . . , K−1), in the form of a sequence of successive blocks with size W, and to write these twiddle factors into corresponding memories of a memory bank, the write being done cyclically in the memory banks, each new set of twiddle factors being written in a new memory bank;
a read management module to read sets of twiddle factors within memories (MEMₖ^{g}) of a memory bank 220_{g} of the processor and to configure the processing stages 210ₖ at the rate of progress of the data blocks through the processing stages; and
a control module to control the write management module the read management module and the progress of data blocks through the processing stages.

2. The NTT stream processor according to claim 1, G+1 wherein G=┌Lat_NTT/T┐, Lat_NTT being the processing latency of the NTT processor and T=N/W is the data sequence flow rate at the input to the NTT processor, each memory bank being associated with the transform of a data sequence and containing the sets of twiddle factors of successive stages for the NTT transform of this sequence.

3. The NTT stream processor according to claim 2, wherein, before a data sequence passes from a first processing stage to a second processing stage, the control module controls reading of the set of twiddle factors in the corresponding memory associated with this second stage within the memory bank associated with this sequence, and programming of the second stage using the set of twiddle factors thus read.

4. The NTT stream processor according to claim 2, wherein the control module comprises a memory banks counter, incremented each time that a new set of twiddle factors is supplied to the write management module and reset to zero after reaching the value G, the output from said counter being compared with a plurality of comparators to be compared with the values g=0, . . . , G, the corresponding outputs from these comparators providing G+1 selection signals enabling one write command in each corresponding memory bank.

5. The NTT stream processor according to claim 4, wherein each memory bank associated with the NTT transformation of a sequence also comprises a register in which is stored the characteristic (pₗ) of the field ( [symbol] ₚ_{ₗ}) in which the NTT transform is made, the characteristic of the field being transmitted to a processing stage at the same time as the twiddle factors read in the memory associated with this stage, in said memory bank.

6. The NTT stream processor according to claim 5, wherein characteristics of the fields in which are made L NTT transforms of L successive data sequences are distinct, wherein L≤G.
